(19) United States
(12) Patent Application Publication
(10) Pub. No.: US 2012/0160958 A1
(43) Pub. Date: Jun. 28, 2012

(54) POWER AND COOLING ARRANGEMENT

(76) Inventor: Gregory D. Stewart, Fishers, IN (US)

(21) Appl. No.: 13/334,565

(22) Filed: Dec. 22, 2011

Related U.S. Application Data
(60) Provisional application No. 61/427,130, filed on Dec. 24, 2010.

(51) Int. Cl. B64D 41/00; F25B 27/00; B23Q 11/00; B60L 1/00; B64D 27/00

(52) U.S. Cl. 244/58; 307/9.1; 244/62; 244/73 R; 62/323.1

(57) ABSTRACT

A vehicle is described having an engine to provide motive transportation and a work producing device used to provide power and thermal conditioning to a payload aboard the vehicle. In one form the work producing device provides power to the payload separate from a network powered by the engine that provides motive transportation. The payload can be a directed energy device in one embodiment. The vehicle can take the form of an aircraft which can be configured to receive the work producing device in a cargo bay/payload bay and/or a pod.

### RELATED APPLICATIONS

The present application claims the benefit of U.S. Provisional Patent Application No. 61/427,130 filed Dec. 24, 2010 which is incorporated herein by reference

### TECHNICAL FIELD

The present invention generally relates to power and thermal conditioning systems, and more particularly, but not exclusively, to power systems separate from vehicle systems.

### BACKGROUND

Providing power to devices carried by a vehicle, but providing the power apart from engines used for transportation of the vehicle, remains an area of interest. Some existing systems have various shortcomings relative to certain applications. Accordingly, there remains a need for further contributions in this area of technology.

### SUMMARY

One embodiment of the present invention is a unique system for providing power to a device aboard a vehicle. Other embodiments include apparatuses, systems, devices, hardware, methods, and combinations for powering and cooling devices using a work producing device separate from engines used to provide motive transportation of the vehicle. Further embodiments, forms, features, aspects, benefits, and advantages of the present application shall become apparent from the description and figures provided herewith.

### BRIEF DESCRIPTION OF THE FIGURES

FIG. 1 depicts one embodiment of an aircraft.

FIG. 2 depicts an embodiment of a work producing device.

FIG. 3 depicts one embodiment of an aircraft.

FIG. 4 depicts an embodiment of an aircraft.

FIG. 5a depicts an embodiment of an aircraft.

FIG. 5b depicts an embodiment of an aircraft.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

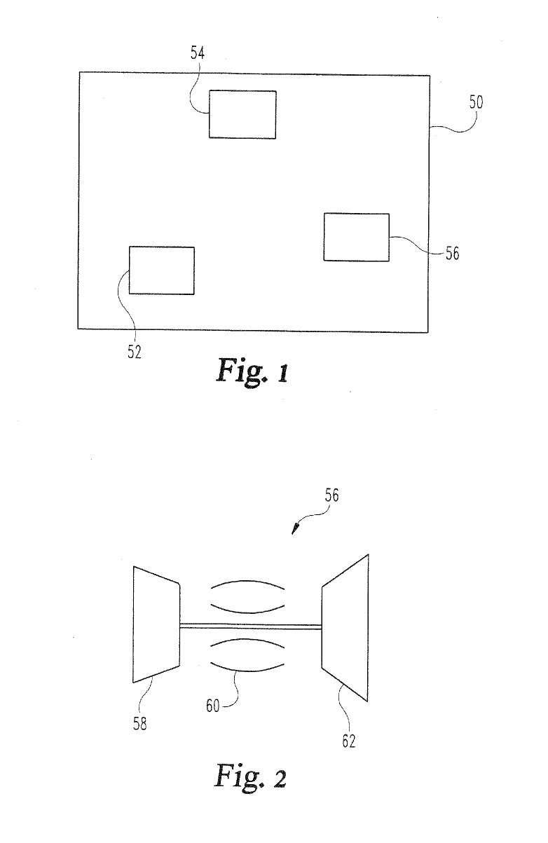

With reference to FIG. 1, an aircraft 50 is depicted having an engine 52 used to propel the aircraft 50. The aircraft 50 can be operated at a variety of altitudes and airspeeds and can take a variety of forms. As will be described further below, the aircraft 50 includes a payload 54 that can be powered by a work producing device 56. As used herein, the term “aircraft” includes, but is not limited to, helicopters, airplanes, unmanned space vehicles, fixed wing vehicles, variable wing vehicles, rotary wing vehicles, unmanned combat aerial vehicles, tailless aircraft, hover crafts, and other airborne and/or extraterrestrial (spacecraft) vehicles. Further, the present inventions are contemplated for utilization in other vehicles such as land-based and/or marine.

Though the aircraft 50 is depicted as having a single engine 52 in the illustrated embodiment, in some forms the aircraft 50 can have multiple engines. Whether having a single or multiple engines, any given engine 52 in any given application can take a variety of forms such as reciprocating engines and gas turbine engines. The engine(s) 52 can be capable of powering useful devices aboard the aircraft 50, such as, but not limited to, cockpit lights, instruments, navigational aids and communication devices, to set forth just a few non-limiting examples. The engine(s) 52 can, but need not be, be used to power a generator and provide environmental control aboard the aircraft 50.

In one embodiment the work producing device 56 can take the form of an ancillary engine. The ancillary engine 56 can be an internal combustion engine which can take on a variety of forms including, but not limited to, a gas turbine engine. In some non-limiting forms the ancillary engine 56 can produce 1 MW in electrical power and can have a rotational speed of one or more turbomachinery components of about 14000 rpm. Examples of the ancillary engine 56 can be the AE1107 gas turbine engine available from Rolls-Royce Corporation, Indianapolis, Ind. In other non-limiting embodiments the ancillary engine 56 can produce other variations in electrical power and rotational speeds both above and below those described above. In one example the power provided by alternative ancillary engines can produce half of the electrical power of that described above. In another non-limiting embodiment the power provided can be one quarter of that described above. In still another embodiments the ancillary engine can produce power on the order of 40 kW and rotational speeds of 6000 rpm. In still further non-limiting embodiments, the power can range from the lowest values listed above to the highest values listed above in 100 kW and/or 1000 rpm step increments. For ease of description below, the work producing device 56 may alternately be called the ancillary engine 56, and in some cases the gas turbine engine 56. The ancillary engine 56 can be a non-propulsive engine in that the engine 56 can provide an insignificant amount of forward power, such as thrust, to the vehicle owing to the location, pressure, and flow rate of its exhaust. Such thrust as might be had from the exhaust can be much less than the thrust provided from the engine(s) 52.

The ancillary engine 56 can be a gas turbine engine, an embodiment of which is shown in FIG. 2. The gas turbine engine can be capable of combusting a mixture of compressed air and fuel and extracting a power to be provided to useful components aboard the aircraft 50, whether that power is mechanical, electrical, or otherwise. In one form the gas turbine engine 56 can include a compressor 58, combustor 60, and turbine 62. Though depicted as a single spool engine, the gas turbine engine 56 can include greater numbers of components such as the compressor and turbine and can additionally include an additional spool(s).

In one embodiment the internal combustion engine can be a production engine used to produce a motive force for an aircraft but otherwise modified to act in a substantially non-propulsive capacity. Such a motive force can include a thrust, such as through a propeller in a turboprop engine or a helicopter rotor of a turboshaft, to set forth just two non-limiting examples. The engine can also provide a thrust through a jet action. To set forth just two non-limiting examples of a production engine, the engine could be an existing helicopter or turboshaft powerplant used in civilian or military applications. The internal combustion engine could also be a variant of a production engine. In one non-limiting embodiment of the variant, the internal combustion engine can be a core from a production engine used to provide a motive thrust for an aircraft, but otherwise modified to be used as a power source having uses described herein. For example, a high pressure compressor, turbine, and combustor can be used from an existing engine and modified for purposes of using the engine as the internal combustion engine described herein.

The ancillary engine 56 can be used to provide power to the payload 54. In one embodiment the payload 54 receives electrical power from the ancillary engine 56, such as through a generator (not shown) that is powered by the ancillary engine 56. Such a generator, and/or associated electronics, can provide electrical power to the payload at a variety of power levels. The payload 54, furthermore, can be capable of receiving AC or DC power. In some forms the payload 54 can have associated electronics to convert, condition, or modify the power received from the generator into a power useful to its system.

In one form the payload 54 can be an energy device capable of producing a directional electromagnetic beam. In some forms the payload 54 can be a directed energy weapon. The weapon system can take the form of a microwave based laser system, or a laser based weapon system, to set forth just two non-limiting examples. The weapon system can be capable of being selectively employed during portions of the operation of the aircraft 50. In certain embodiments, some portions of the weapon system can be powered while others are not. In some applications the weapon system can be powered substantially during the entire operation of the aircraft, while in other applications the weapon system is substantially non-active.

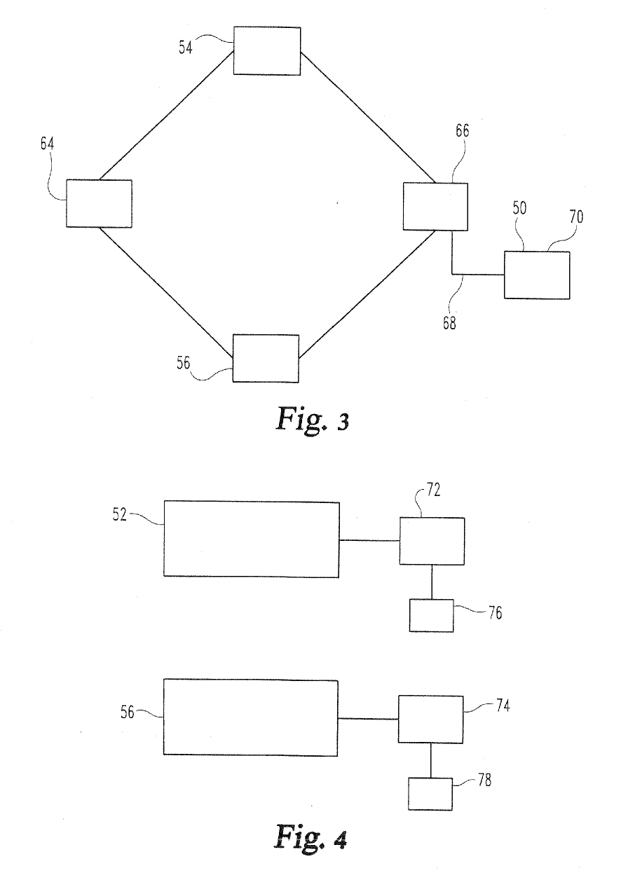

Turning now to FIG. 3, in one embodiment of the instant application the work producing device 56 can be used to power and provide thermal conditioning to the payload 54. In one non-limiting form the work producing device 56 is capable of providing electrical power to the payload 54 via a generator 64 which can either be integrated with or separate from the work producing device 56. In some forms the work producing device 56 can transfer work to the payload 54 in which the integrated generator 64 is integrated, such as through a shaft arrangement that powers the generator 64. Multiple other techniques of transferring work from the work producing device 56 and providing electricity to power the payload 54 are contemplated herein.

A thermal conditioning system 66 is depicted in FIG. 3 and can be used to transfer heat with the payload 54. In one embodiment the thermal conditional system 66 is used to cool the payload 54 and takes the form of a cyclic refrigeration system which can operate on the basis of a vapor compression cycle. The thermal conditioning system 66 can include a working fluid 68 that circulates within the system 66 and is used to transfer heat with the payload 54. The working fluid 68 can be used to receive heat from the payload 54 and can be routed to dissipate that heat with a portion 70 of the aircraft 50 in thermal communication with a passing airstream. The working fluid 68 can be circulated between the payload 54 and the portion 70 of the aircraft 50. In one non-limiting embodiment the portion 70 is near a skin of the aircraft such that heat can be conducted between the passing air stream and the working fluid 68.

The thermal conditioning system 66 can include a compressor, condenser, and evaporator. The compressor is used to pressurize the working fluid 68 which results in a corresponding increase pressure of the fluid 68. After being pressurized by the compressor the working fluid 68 can be conveyed via a passage to the condenser which is used to withdraw heat from the working fluid 68 and in some cases condense it to a liquid state. In some embodiments the condenser can be located near the portion 70. In some forms the passage that conveys the working fluid 68 can simultaneously be used as the condenser. Some devices, such as fins, can be coupled with the passage and/or condenser to assist in withdrawing heat from the working fluid 68. As used herein, the term “passage” includes any variety of spaces suitable for conveying a fluid. The spaces can have any size, shape, orientation, etc. and can be capable of flowing fluids at a variety of pressures, temperature, and flow rates, from relatively high to relatively low.

The evaporator receives the compressed working fluid 68 via a passage at a relatively low temperature. In one non-limiting form the evaporator is in thermal communication with and receives heat from the payload 54. The evaporator can be in direct contact with the payload 54 or can be positioned some distance from it. In some applications additional devices may be coupled between the evaporator and the payload 54 which can be used to convey heat between the two. In some forms a flow of fluid such as air, water, or polyalphaolefin, can be moved between the evaporator and the payload 54 to transfer heat between the two.

Turning now to FIG. 4, one embodiment of the aircraft 50 in at least one mode of operation is depicted in which each of the engine 52 and work producing device 56 are configured to provide power to devices through isolated electrical busses 72 and 74, respectively. Such devices coupled to the busses are depicted in the figure having reference numerals 76 and 78. In one form the electrical bus 72 is electrically isolated and unable to influence the electrical bus 74. Accordingly, the busses 72 and 74 can be operated independent of each other at varying power levels, for example. Electrical power generated by engine 52, for example through a generator driven by the engine 52, is unable to influence current or potential differences in any part of the electrical bus 74 and devices connected thereto. It will be appreciated that although the embodiment of FIG. 4 is simply depicted in schematic form, other embodiments of the aircraft may incorporate electrical networks of greater complexity that are also isolated from each other. Such isolation protects each network from faults, disturbances, and/or failures from the other.

Though only a single device is depicted coupled to each of the busses 72 and 74, greater numbers of devices can be used. Though some devices coupled to the one network may be in physical proximity to devices of the other network, the networks of the illustrative embodiment are themselves electrically isolated and unable to influence to any significant degree the operation of the other network.

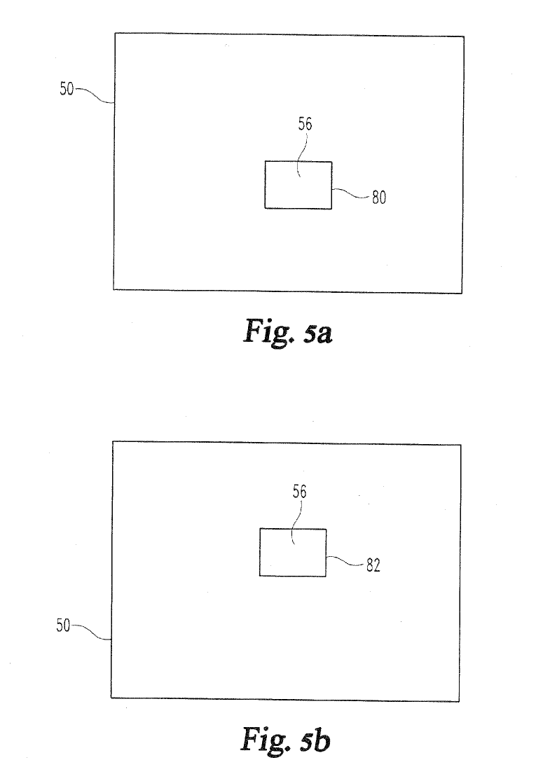

Turning now to FIGS. 5a and 5b, embodiments of the aircraft 50 are shown having the work producing device 56 in various locations. FIG. 5a depicts the work producing device 56 located in a cargo bay/payload bay 80 of the aircraft 50. Examples of area 80 include, but are not limited to, spaces in which personnel and/or materials are located during a flight of the aircraft. The area 80 can be spaces such as those within military aircraft like the C-130, C-135, H53, OH-6, AH-1 etc, or civilian aircraft such as a B747, King Air 350, among a variety of other aircraft. The area 80 can be partitioned from other areas of the aircraft to create a separate space for the engine. The area 80, furthermore, can be structurally apart from other areas that are used for personnel and/or materials. To set forth just one non-limiting example, a bulkhead can be located between the area used for the engine and an area used for personnel and/or materials. The terms cargo bay/payload bay are terms that include spaces not limited to areas strictly designated for carriage of cargo or payloads but generally indicates an interior space of the aircraft such as an interior of a fuselage.

The embodiment depicted in FIG. 5a permits the work producing device 56 to be rolled on and off of the aircraft 50. In the form of an internal combustion engine, such as a gas turbine engine, a pallet can be used on which the work producing device 56 is mounted and which is moved along a series of rollers to position the work producing device 56 within the cargo bay/payload bay 80. The work producing device 56 can be coupled with a cart having wheels that can be rolled on and off the aircraft. In other applications the work producing device can be wheeled aboard an aircraft through the use of a forklift or other similar aid.

In some forms the work producing device 56 can be coupled to one of the payload 54, bus 74, or thermal conditioning system 66 at the same time that it is loaded on or removed from the aircraft 50. In other forms the work producing device 56 can be separately brought into the cargo bay/payload bay 80 and then coupled with an installed one or more of the payload 54, bus 74, or thermal conditioning system 66.

FIG. 5b depicts an additional and/or alternative arrangement in which the work producing device 56 is located in a pod 82. The pod 82 of the illustrated embodiment is coupled to the aircraft 50 and can be located such that it projects into a free stream. The pod 82 can be releasably coupled to the aircraft 50 or can be permanently affixed thereto. In one form the pod 82 includes a shape similar to an external fuel tank. The pod 82 can be located beneath a wing or a centerline of an aircraft, among other possible locations. The pod 82 can have a leading edge and a trailing edge and in one form has a symmetric shape about one or more axes or planes. In other embodiments the pod 82 need not be symmetric. The pod 82 can take a variety of forms and need not be entirely exposed to the free stream such as an external fuel tank is exposed. In some embodiments the pod 82 can take the form of a conformal fuel tank used on some types of aircraft to increase a load carrying capacity. Such a conformal structure need not be exposed to the free stream as some external fuel tanks are exposed.

The embodiment depicted in FIG. 5b permits the work producing device 56 to be quickly coupled and decoupled from the aircraft. In some forms the work producing device 56 can be coupled to one of the pod 82, payload 54, bus 74, or thermal conditioning system 66 at the same time that the pod 82 is attached or removed from the aircraft 50. In other forms the work producing device 56 can be attached to the aircraft 50 while in the pod 82 and then coupled with an installed one or more of the payload 54, bus 74, or thermal conditioning system 66.

One aspect of the present application provides an apparatus comprising: a vehicle having a propulsion engine capable of generating forward movement of the vehicle, the vehicle also including a first electrical network providing power to vehicle devices, an internal combustion engine coupled with the vehicle and structured to provide electrical power and thermal management to a load aboard the vehicle, the internal combustion engine structured to drive a generator for the production of electrical power and provide power to a refrigeration system, the generator structured to provide electrical power to a second electrical network isolated from the first electrical network, and a directed energy device capable of converting electrical power into a directed electromagnetic beam, the directed energy device located with the vehicle and driven by the generator, the directed energy device including a portion that when operated emits heat, the portion in thermal communication with the refrigeration system.

One aspect of the present application provides wherein the vehicle is an aircraft and the propulsion engine is structured to generate forward thrust.

Another aspect of the present application provides wherein the internal combustion engine is located in an external store, and wherein the internal combustion engine is a gas turbine engine.

Yet another aspect of the present application provides wherein the internal combustion engine is located in an interior payload space of the aircraft.

Still yet another aspect of the present application provides wherein the internal combustion engine can be decoupled and rolled off of the aircraft.

A further aspect of the present application provides wherein the refrigeration system is a vapor compression refrigeration system.

A still further aspect of the present application provides wherein the refrigeration system includes a working fluid in thermal communication with an air stream passing external of the vehicles.

Yet still a further aspect of the present application provides wherein the second electrical network is physically isolated from the first electrical network such that a disturbance in one is not propagated to the other.

Another aspect of the present application provides an apparatus comprising: an aircraft having a powerplant capable of propelling the aircraft at a flight speed, the aircraft also including a first electrical network providing power to aircraft devices, a non-propulsive internal combustion engine located in an interior cargo space of the aircraft and capable of driving a generator to generate electrical power, the engine capable of providing power to drive a cooling system having a working fluid therein, and an electrically driven device capable of converting an electric power provided by the generator and developing a heat when operated, the device in thermal communication with the working fluid.

Another aspect of the present application provides wherein the electrical power is provided by the generator to a second electrical network.

Yet another aspect of the present application provides wherein the first electrical network is isolated from the second electrical network.

Still yet another aspect of the present application provides wherein the first electrical network is isolated from the second electrical network such that faults in the second network do not substantially adversely impact the first network.

A further aspect of the present application provides wherein the internal combustion engine is a gas turbine engine.

A still further aspect of the present application provides wherein a core of the gas turbine engine is substantially the same as a core used in a propulsive powerplant.

Yet still a further aspect of the present application provides wherein the electrically driven device is a directed energy device capable of producing a directed electromagnetic emission.

Still yet a further aspect of the present application provides wherein the working fluid is in thermal communication with an air stream.

Yet another aspect of the present application provides a method comprising: propelling an aircraft with one or more thrust producing engines, providing an electrical power to an aircraft electrical bus, operating a work producing device apart from the thrust producing engines, powering an ancillary electrical bus separate from the aircraft electrical bus, the powering provided from the work producing device, and using work from the work producing device to cool a relatively high temperature device.

Another aspect of the present application provides wherein the work producing device is an internal combustion engine and wherein the operating includes combusting a fuel.

Still another aspect of the present application further includes producing a directional electromagnetic beam with electricity produced from the work producing device.

Still yet another aspect of the present application further includes flowing a working fluid in a cooling system from work provided by the work producing device.

Still a further aspect of the present application provides wherein the flowing includes running a compressor to provide a pressure to the working fluid.

A vehicle is described having an engine to provide motive transportation and a work producing device used to provide power and thermal conditioning to a payload aboard the vehicle. In one form the work producing device provides power to the payload separate from a network powered by the engine that provides motive transportation. The payload can be a directed energy device in one embodiment. The vehicle can take the form of an aircraft which can be configured to receive the work producing device in a cargo bay/payload bay and/or a pod.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a vehicle having a propulsion engine capable of generating forward movement of the vehicle, the vehicle also including a first electrical network providing power to vehicle devices;
an internal combustion engine coupled with the vehicle and structured to provide electrical power and thermal management to a load aboard the vehicle, the internal combustion engine structured to drive a generator for the production of electrical power and provide power to a refrigeration system, the generator structured to provide electrical power to a second electrical network isolated from the first electrical network; and
a directed energy device capable of converting electrical power into a directed electromagnetic beam, the directed energy device located with the vehicle and driven by the generator, the directed energy device including a portion that when operated emits heat, the portion in thermal communication with the refrigeration system.

2. The apparatus of claim 1, wherein the vehicle is an aircraft and the propulsion engine is structured to generate forward thrust.

3. The apparatus of claim 2, wherein the internal combustion engine is located in an external store, and wherein the internal combustion engine is a gas turbine engine.

4. The apparatus of claim 2, wherein the internal combustion engine is located in an interior payload space of the aircraft.

5. The apparatus of claim 4, wherein the internal combustion engine can be decoupled and rolled off of the aircraft.

6. The apparatus of claim 1, wherein the refrigeration system is a vapor compression refrigeration system.

7. The apparatus of claim 6, wherein the refrigeration system includes a working fluid in thermal communication with an air stream passing external of the vehicles.

8. The apparatus of claim 1, wherein the second electrical network is physically isolated from the first electrical network such that a disturbance in one is not propagated to the other.

9. An apparatus comprising:
an aircraft having a powerplant capable of propelling the aircraft at a flight speed, the aircraft also including a first electrical network providing power to aircraft devices;
a non-propulsive internal combustion engine located in an interior cargo space of the aircraft and capable of driving a generator to generate electrical power, the engine capable of providing power to drive a cooling system having a working fluid therein; and
an electrically driven device capable of converting an electric power provided by the generator and developing a heat when operated, the device in thermal communication with the working fluid.

10. The apparatus of claim 9, wherein the electrical power is provided by the generator to a second electrical network.

11. The apparatus of claim 10, wherein the first electrical network is isolated from the second electrical network.

12. The apparatus of claim 11, wherein the first electrical network is isolated from the second electrical network such that faults in the second network do not substantially adversely impact the first network.

13. The apparatus of claim 9, wherein the internal combustion engine is a gas turbine engine.

14. The apparatus of claim 13, wherein a core of the gas turbine engine is substantially the same as a core used in a propulsive powerplant.

15. The apparatus of claim 9, wherein the electrically driven device is a directed energy device capable of producing a directed electromagnetic emission.

16. The apparatus of claim 9, wherein the working fluid is in thermal communication with an air stream.

17. A method comprising:
propelling an aircraft with one or more thrust producing engines;
providing an electrical power to an aircraft electrical bus;
operating a work producing device apart from the thrust producing engines;
powering an ancillary electrical bus separate from the aircraft electrical bus, the powering provided from the work producing device; and
using work from the work producing device to cool a relatively high temperature device.

18. The method of claim 17, wherein the work producing device is an internal combustion engine and wherein the operating includes combusting a fuel.

19. The method of claim 17, which further includes producing a directional electromagnetic beam with electricity produced from the work producing device.

20. The method of claim 17, which further includes flowing a working fluid in a cooling system from work provided by the work producing device.

21. The method of claim 20, wherein the flowing includes running a compressor to provide a pressure to the working fluid.
